(19) United States
(12) Patent Application Publication
(10) Pub. No.: US 2006/0012303 A1
(43) Pub. Date: Jan. 19, 2006

(54) Plasma display panel

(75) Inventors: Tasuku Ishibashi, Yamanashi-ken (JP); Yoichi Okumura, Yamanashi-ken (JP); Masaki Yoshinari, Yamanashi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/176,659

(22) Filed: Jul. 8, 2005

(30) Foreign Application Priority Data
Jul. 14, 2004 (JP) 2004-207655

(51) Int. Cl. H01J 17/49

(52) U.S. Cl. 313/582

(57) ABSTRACT

A plurality of row electrode pairs and a dielectric layer covering the row electrode pairs are formed on the back-facing face of the front glass substrate. Phosphor layers are formed on the front-facing face of the back glass substrate for each discharge cell. Protuberances formed of dielectric are formed on portions of the dielectric layer each opposing a discharge gap between the opposing transparent electrodes of the paired row electrodes. Each of the protuberances extends outward from the dielectric layer into the discharge cell toward the back glass substrate. A floating electrode is formed in the protuberance.

### BACKGROUND OF THE INVENTION

1. Field of the Invention

This invention relates to a panel structure for a surface-discharge-type alternating-current plasma display panel.

The present application claims priority from Japanese Application No. 2004-207655, the disclosure of which is incorporated herein by reference.

2. Description of the Related Art

FIG. 1 is a sectional view of a conventional plasma display panel (hereinafter referred to as “PDP”) taken along the column direction (the vertical direction of the panel) to show the structure.

The conventional PDP in FIG. 1 has a front glass substrate 1 provided on a face thereof which faces toward the back of the panel (hereinafter referred to as “back-facing face”) with a plurality of row electrode pairs (X, Y) each constituted of a pair of row electrodes X, Y facing each other across a discharge gap g, and a dielectric layer 2 covering the row electrode pairs. The front glass substrate 1 is opposite a back glass substrate 3 with a discharge space in between. The back glass substrate 3 is provided on a face thereof which faces toward the display surface (hereinafter referred to as “front-facing face”) with a plurality of column electrodes D that form discharge cells C in the display space at the intersections with the row electrode pairs (X, Y), a column-electrode protective layer 4 that covers the column electrodes D, a partition wall unit 5 that is formed on the column-electrode protective layer 4 to partition the discharge space into the discharge cells C, and phosphor layers 6 to which the three primary colors, red, green and blue, are applied for each display cell C.

Further, the PDP has dielectric projections 7 each projecting into the discharge cell C from a portion of the back-facing face of the dielectric layer 2 opposite the discharge gap g between the opposing transparent electrodes Xa and Ya of the row electrodes X and Y.

Such a conventional PDP is disclosed in Japanese unexamined patent publication 2003-257320, for example.

The conventional PDP produces an address discharge between the row electrode Y and the column electrode D, and uses the surface discharge to initiate a sustaining discharge d between the transparent electrodes Xb and Yb of the row electrodes X and Y facing each other across the discharge gap g in each of the discharge cells C which have been selected through the address discharge. At the time when the sustaining discharge induces light emission from the phosphor layer 6, as shown in FIG. 1, the sustaining discharge d is initiated along the surface of the dielectric projection 7 projecting from the dielectric layer 2 into the discharge cell C so as to be diverted in the direction of the center of the discharge cell C.

Accordingly, in this PDP the sustaining discharge is initiated near the central portion of the discharge cell C. This gives rise to an increase in the amount of vacuum ultraviolet light traveling toward the phosphor layer 6 out of the total amount of vacuum ultraviolet light generated from the discharge gas filling the discharge space, as compared with that in previous PDPs. This results in the exertion of the technical effect of improving the luminous efficiency of the PDP because of the increase in the efficiency of use of the available amount of vacuum ultraviolet light.

However, this PDP has an increase in the discharge path of the sustaining discharge d as a result of the provision of the dielectric projection 7, as compared with previous PDPs. In consequence, a further problem arises of an increase in the discharge voltage for the sustaining discharge, leading to an increase in the electric power consumption.

### SUMMARY OF THE INVENTION

It is an object of the present invention to solve the problems associated with the conventional PDPs as described above.

To attain this object, a plasma display panel according to the present invention has a pair of substrates placed opposite each other across a discharge space, one of the pair of substrates being provided on its inner surface with a plurality of row electrode pairs each extending in the row direction and arranged in the column direction and a dielectric layer covering the row electrode pairs, the discharge space being partitioned into areas to form unit light emitting areas each corresponding to paired discharge portions that are opposite each other across a discharge gap constituted by parts of row electrodes constituting each of the row electrode pairs, and the other substrate being provided on its inner face with phosphor layers for the respective unit light emitting areas. The plasma display panel is characterized in that dielectric protuberances each extend out from a portion of the dielectric layer opposite the discharge gap between the row electrode pair toward the other substrate into the unit light emitting area and floating electrodes are provided in the dielectric protuberances and out of electric connection with the others.

In the best mode for carrying out the present invention, a PDP has a dielectric layer covering row electrode pairs formed on the back-facing face of a front glass substrate, and dielectric-formed protuberances each formed on a portion of the dielectric layer that is positioned opposite a discharge gap between paired and opposing transparent electrodes of the row electrodes and extending out from a dielectric layer into a discharge cell. Further, floating electrodes are provided in the protuberances without electric connection with the others of the PDP.

In the PDP in the best mode, because each of the dielectric protuberances is formed in such a manner as to each extend out from the back-facing face of the dielectric layer into the discharge cell, the sustaining discharge caused between the transparent electrodes of the row electrodes opposing each other across the discharge gap is initiated in an area close to the center of the discharge cell along the surface of the protuberance, namely, an area near the phosphor layer formed on the back glass substrate which is placed opposite the front glass substrate with the discharge space in between. In consequence, the efficiency of use of the available amount of vacuum ultraviolet light generated from the discharge gas in the discharge cell as a result of the sustaining discharge is increased, leading to an improvement of the efficiency of light emission from the phosphor layers.

Further, by forming the floating electrode in the protuberance, the discharge voltage will not build up even though the discharge path of the sustaining discharge is increased by the formation of the protuberance. Further, room is allowed for discharges between the floating electrode and the transparent electrodes between which the sustaining discharge is initiated. This increases the electric filed strength in the site of occurrence of the discharge, which in turn reduces the discharge voltage.

These and other objects and features of the present invention will become more apparent from the following detailed description with reference to the accompanying drawings.

### BRIEF DESCRIPTION OF THE DRAWINGS

FIG. 1 is a sectional view illustrating the structure of a conventional PDP.

FIG. 2 is a schematic front view of a first embodiment according to the present invention.

FIG. 3 is a sectional view taken along the V1-V1 line in FIG. 2.

FIG. 4 is a schematic front view of a second embodiment according to the present invention.

FIG. 5 is a schematic front view of a third embodiment according to the present invention.

FIG. 6 is a sectional view taken along the V2-V2 line in FIG. 5.

### DETAILED DESCRIPTION OF THE PREFERRED EMBODIMENTS

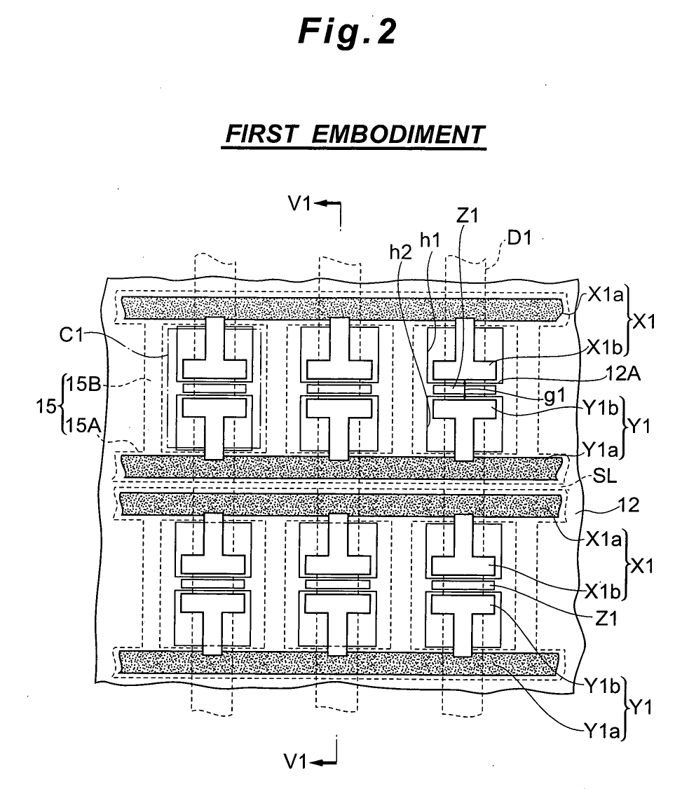

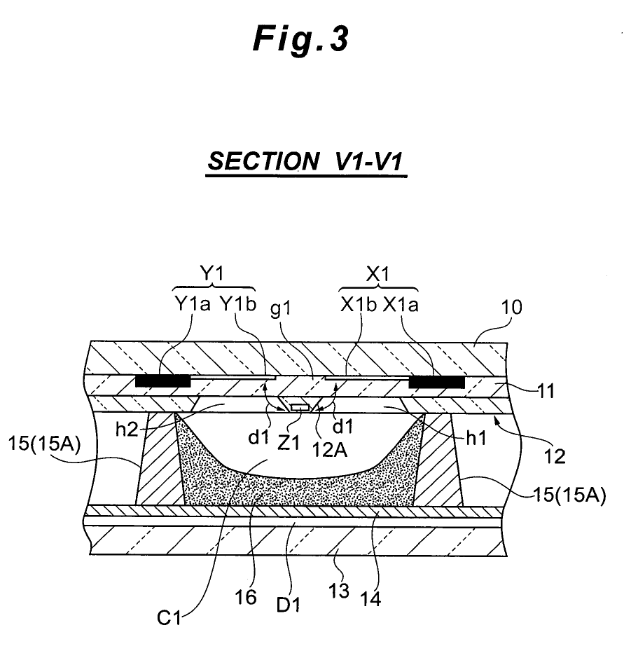

FIGS. 2 and 3 illustrate a first embodiment of a PDP according to the present invention. FIG. 2 is a schematic front view of the PDP in the first embodiment. FIG. 3 is a sectional view taken along the V1-V1 line in FIG. 2.

The PDP shown in FIGS. 2 and 3 has a front glass substrate 10 serving as the display surface which is provided on its back-facing face with a plurality of row electrode pairs (X1, Y1) each extending in the row direction (the right-left direction in FIG. 2) of the front glass substrate 10 and arranged parallel to each other.

The row electrode X1 constituting part of a row electrode pair (X1, Y1) is composed of a strip-shaped bus electrode X1a formed of a metal film extending in the row direction, and T-shaped transparent electrodes X1b that are formed of a transparent conductive film made of ITO or the like and respectively connected to the bus electrode X1a at regularly spaced intervals to extend outward therefrom toward their counterpart row electrode Y1 in the column direction (the vertical direction in FIG. 2).

Likewise, the row electrode Y1 is composed of a strip-shaped bus electrode Y1a formed of a metal film extending in the row direction, and T-shaped transparent electrodes Y1b that are formed of a transparent conductive film made of ITO or the like and respectively connected to the bus electrode Y1a at regularly spaced intervals to extend outward therefrom toward their counterpart row electrode X1 in the column direction (the vertical direction in FIG. 2).

The row electrodes X1 and Y1 are arranged in alternate positions in the column direction of the front glass substrate 10. In each row electrode pair (X1, Y1), the broad top ends (corresponding to the head of the “T”) of the paired transparent electrodes X1b and Y1b disposed along the associated bus electrodes X1a and Y1a face each other across a discharge gap g1 of a required width.

A dielectric layer 11 is formed on the back-facing face of the front glass substrate 10 and covers the row electrode pairs (X1, Y1).

An additional dielectric layer 12 is further formed on the back-facing face of the dielectric layer 11.

The additional dielectric layer 12 extends outward from the dielectric layer 11 in a direction opposite to the front glass substrate 10 in the whole of the area except quadrangular areas h1, h2 corresponding to the transparent electrodes X1b, Y1b of the row electrodes X1, Y1 on the back-facing face of the dielectric layer 11.

Strip-shaped protuberances 12A are formed integrally with the additional dielectric layer 12. Each of the protuberances 12A extends in the row direction in an area opposing the discharge gap g1 between the paired transparent electrodes X1b and Y1b.

A floating electrode Z1 extends in each of protuberances 12A along the tops of the broad ends of the transparent electrodes X1b, Y1b, while being opposite the mid-position of the discharge gap g1.

The floating electrode Z1 is out of connection with other electrodes and so on, and formed in an isolated-island form in each area opposing the discharge gap g1.

An MgO protective layer (not shown) is formed on and covers the back-facing face of the dielectric layer 11 and the additional dielectric layer 12.

The front glass substrate 10 is placed parallel to a back glass substrate 13 with a discharge space in between. The back glass substrate 13 is provided on its front-facing face with column electrodes D1 that each extend in a direction at right angles to the row electrode pairs (X1, Y1) (i.e. the column direction) along an area opposite the paired transparent electrodes X1a and Y1a of the row electrode pairs (X1, Y1), and are arranged parallel to each other at predetermined intervals.

A white-colored column-electrode protective layer 14 is further formed on the back glass substrate 13 and covers the column electrodes D1.

Partition wall units 15 are formed on the column-electrode protective layer 14.

Each of the partition wall units 15 is formed in an approximate ladder shape made up of a pair of lateral walls 15A extending in the row direction in the respective areas opposite the bus electrodes X1a and Y1a of the row electrode pair (X1, Y1), and vertical walls 15B each extending between the pair of lateral walls 15A in the column direction in a mid-area between the adjacent column electrodes D1. The partition wall units 15 are regularly arranged in the column direction with interstices SL each interposed between back-to-back lateral walls 15A of adjacent partition wall units 15.

The ladder-shaped partition wall units 15 partition the discharge space defined between the front glass substrate 10 and the back glass substrate 13 into quadrangular discharge cells C1 in correspondence with the paired transparent electrodes X1b, Y1b in each row electrode pair (X1, Y1).

Phosphor layers 16 are respectively formed in the discharge cells C1 so as to cover all the five faces facing each discharge cell C1: the side faces of the lateral walls 15A and the vertical walls 15B of the partition wall unit 15 and the front-facing face of the column-electrode protective layer 14. The phosphor layers 16 are individually colored such that the three primary colors, red, green and blue, for each discharge cell C1 are arranged in order in the row direction.

A portion of the protective layer covering the additional dielectric layer 12 is in contact with the front-facing faces of the lateral walls 15A and the vertical walls 15B of each partition wall unit 15 (see FIG. 3) to block each discharge cell C1 from the discharge cells C1 adjacent thereto in the row direction and from the interstices SL.

Each of the discharge cells C1 is filled with a discharge gas including xenon.

The above PDP produces reset discharges simultaneously between all the paired transparent electrodes X1b and Y1b of the row electrode pairs (X1, Y1) in a reset period for the generation of an image. The reset discharge results in complete erasure of the wall charge on the portion of the dielectric layer 11 adjoining each discharge cell C1 (alternatively, deposition of wall charge on the portion of the dielectric layer 11 adjoining each discharge cell C1).

In the following address discharge period, an address discharge is produced selectively between the transparent electrode Y1b of the row electrode Y1 to which a scan pulse is applied and the column electrode D1 to which a data pulse is applied. The address discharge results in the distribution of the light-emitting cells with the deposition of wall charge on the dielectric layer 11 and the non-light-emitting cells which have had the wall charge erased from the dielectric layer 11, over the panel surface in accordance with the image data of the video signal.

In the following sustaining discharge period, a sustaining pulse is applied alternately to the row electrode X1 and Y1 in order to produce a sustaining discharge d1 between paired transparent electrodes X1b and Y1b of the row electrode pair (X1, Y1) in each of the light-emitting cells. The sustaining discharge d1 causes radiation of vacuum ultraviolet light from the xenon included in the discharge gas. The vacuum ultraviolet light excites the red-, green- and blue-colored phosphor layers 16 to permit them to emit light for the generation of an image on the panel surface.

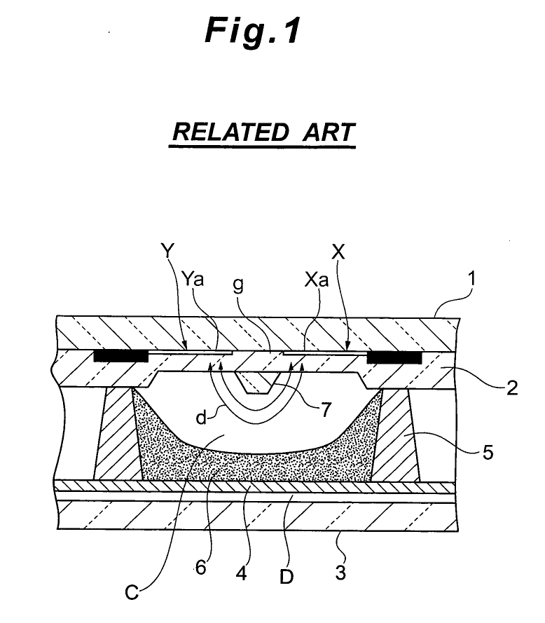

When this sustaining discharge D1 occurs, a potential difference is caused between the floating electrode Z1 placed in isolated-island form in each protuberance 12A of the additional dielectric layer 12 and having a floating potential, and the transparent electrode X1b or Y1b to which the sustaining pulse is applied. Therefore, the sustaining discharge D1 occurring along the surface of the protuberance 12A in such a way as to be diverted in the direction of the center of the discharge cell C1 passes through the floating electrode Z1. For this reason, the discharge path of the sustaining discharge D1 is shortened as compared with that in the conventional PDP described in FIG. 1.

Further, the location of the floating electrode Z1 in the protuberance 12A extending out toward the center of the discharge cell C1 allows room for generating discharges between the transparent electrodes X1b, Y1b and the floating electrode Z1. This increases the electric field strength in the site of occurrence of the discharge, which in turn reduces the discharge voltage for the sustaining discharge D1.

As described above, in the structure of the PDP, the dielectric-formed protuberance 12A extending out from the back-facing face of the dielectric layer 11 toward the interior of the discharge cell C1 allows the sustaining discharge D1 to develop in an area along the surface of the protuberance 12A close to the phosphor layer 16. As a result, the efficiency of use of the vacuum ultraviolet light generated from the discharge gas is increased, and this increase enables an improvement in the luminous efficiency from the phosphor layers 16.

Because of the location of the floating electrode Z1 in the protuberance 12A, although the discharge path of the sustaining discharge D1 is increased by the provision of the protuberance 12A, the discharge voltage will not build up. Further, because room is allowed for initiating discharges between the transparent electrodes X1b, Y1b and the floating electrodes Z1, the electric field strength in the site of occurrence of the discharge is increased, leading to a reduction in the discharge voltage.

The PDP has the transparent electrodes X1b, Y1b of the row electrodes X1, Y1 each formed in a T shape and disposed in such a way as to make their broad ends face each other across a discharge gap g1. This design produces the sustaining discharge intensively from around the broad ends of the transparent electrodes X1b, Y1b, and thus inhibits the dispersion of discharge current into the surrounding areas, which in turn also improves the luminous efficiency.

The additional dielectric layer 12 extends out from the back-facing face of the dielectric layer 11, except for the portions thereof each opposing the paired transparent electrodes X1b, Y1b, into each discharge cell C1 so as to surround the opposing portions of these transparent electrodes X1b, Y1b. Thereby, the occurrence of a so-called “shifting-aside” or a false discharge of the sustaining discharge produced between the transparent electrodes X1b, Y1b is prevented. Further, the electric field strength of the surface discharge (sustaining discharge) produced between the transparent electrodes X1b, Y1b is increased to reduce the discharge voltage.

The following is the procedure for manufacturing the foregoing PDP.

In the manufacturing process for the front glass substrate 10, first, the bus electrodes X1a, Y1a and the transparent electrodes X1b, Y1b are formed on the back-facing face of the front glass substrate 10 by means of patterning to form row electrodes X1, Y1.

After that, the dielectric layer 11 is further formed on the back-facing face of the front glass substrate 10 so as to cover the row electrodes X1, Y1.

After the formation of the dielectric layer 11, the additional dielectric layer 12 is formed on the back-facing face of the dielectric layer 11. At this point, the floating electrodes Z1 are formed in the protuberances 12A of the additional dielectric layer 12.

For forming the floating electrodes Z1, for example, each of the protuberances 12A of the additional dielectric layer 12 is divided into two layers in order to be formed in stages. After the first layer has been formed, the floating electrode Z1 is formed, and then the second layer is formed so as to cover the floating electrode Z1.

The floating electrode Z1 is formed by use of methods such as lamination of a silver film, solid printing of a photosensitive silver paste, pattern printing of a silver paste, Cr—Al—Cr evaporation, Al evaporation, or forming an ITO film.

After the formation of the additional dielectric layer 12 and the floating electrodes Z1, the MgO protective layer is formed to cover the surfaces of the dielectric layer 11 and the additional dielectric layer 12.

In the manufacturing process for the back glass substrate 13, the column electrodes D1 are formed on the front-facing face of the back glass substrate 13, then the column-electrode protective layer 14 is formed to cover the column electrodes D1.

After that, the partition wall units 15 are formed on the column-electrode protective layer 14, and then the red-, green- and blue-colored phosphor layers 16 are formed individually in the blank spaces created in each of the partition wall units 15.

Then, a sealing layer is formed on the periphery end of the front-facing face of the back glass substrate 13.

The front glass substrate 10 on which the components have been thus formed in the front-glass-substrate manufacturing process and the back glass substrate 13 on which the components have been thus formed in the back-glass-substrate manufacturing process are placed on and aligned with each other with the discharge space in between. Then, various processes, such as the sealing process for the discharge space and the process of removing gases from the interior of the discharge space and of baking, the process of introducing a discharge gas into the discharge space, and the chip-off process for the discharge gas, are performed in order to complete the PDP.

Second Embodiment

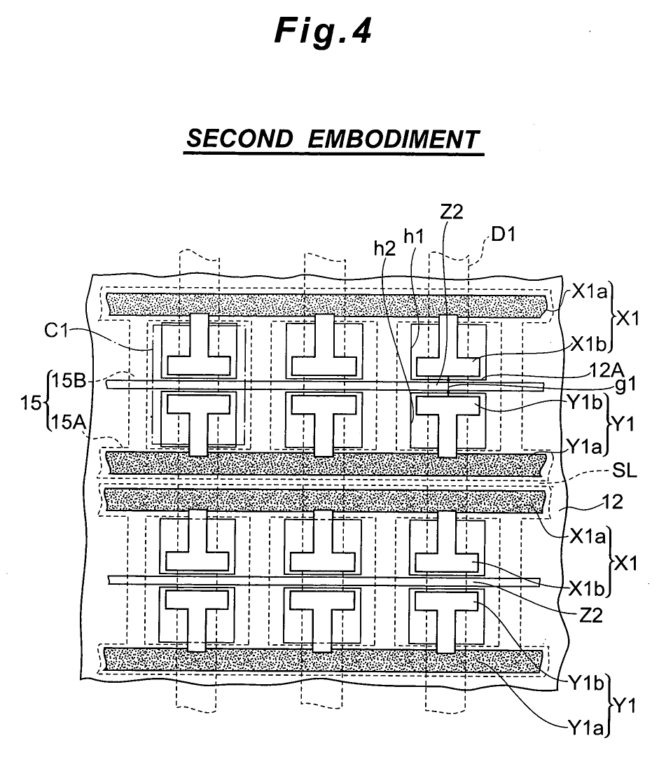

FIG. 4 is a front view illustrating a second embodiment of a PDP according to the present invention.

The first embodiment has described a PDP having the floating electrodes Z1 each formed in an isolated-island form independently in each discharge cell C1, whereas the PDP described in the second embodiment has floating electrodes Z2 each formed in the additional dielectric layer 12 in a strip shape extending in the row direction through the protuberances 12A each formed in the portion opposite the discharge gap g1 between the transparent electrodes X1b, Y1b.

The structure of the other components in this PDP is approximately the same as that in the first embodiment, and in FIG. 4 the same components are designated with the same reference numerals as those in the first embodiment.

As in the case of the PDP in the first embodiment, in the PDP in the second embodiment the dielectric-formed protuberance 12A extending out into the interior of the discharge cell C1 in the portion opposite the discharge gap g1 allows the sustaining discharge between the transparent electrodes X1b, Y1b to develop in an area close to the central portion of the discharge cell C1. As a result, the efficiency of use of the vacuum ultraviolet light generated from the discharge gas is increased, and this increase enables an improvement in the luminous efficiency from the phosphor layers. Further, because of the location of the floating electrode Z2 in the protuberances 12A, although the discharge path of the sustaining discharge is increased by the provision of the protuberance 12A, the discharge voltage will not build up. Further, because room is allowed for initiating discharges between the transparent electrodes X1b, Y1b and the floating electrodes Z2, the electric field strength in the discharge occurring site is increased, leading to a reduction in discharge voltage.

Third Embodiment

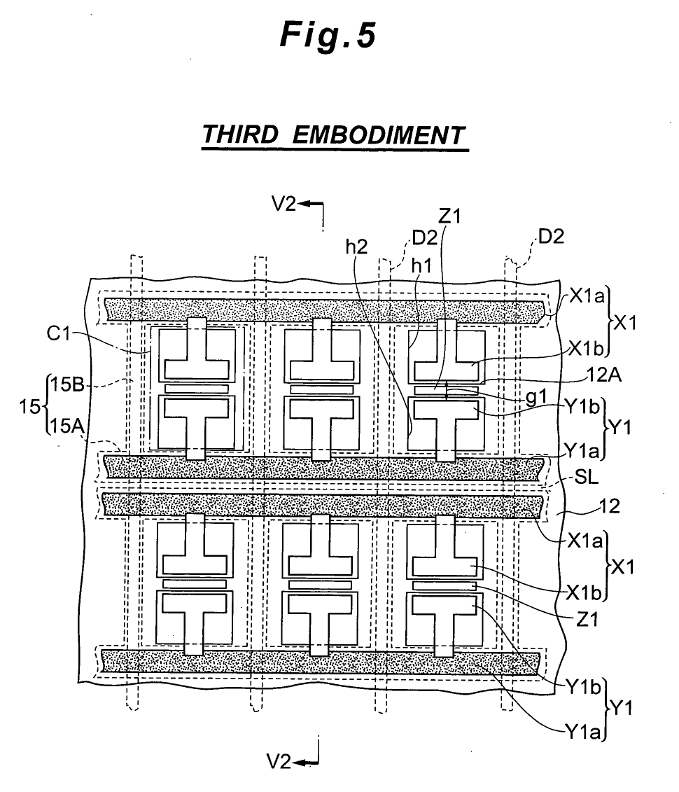

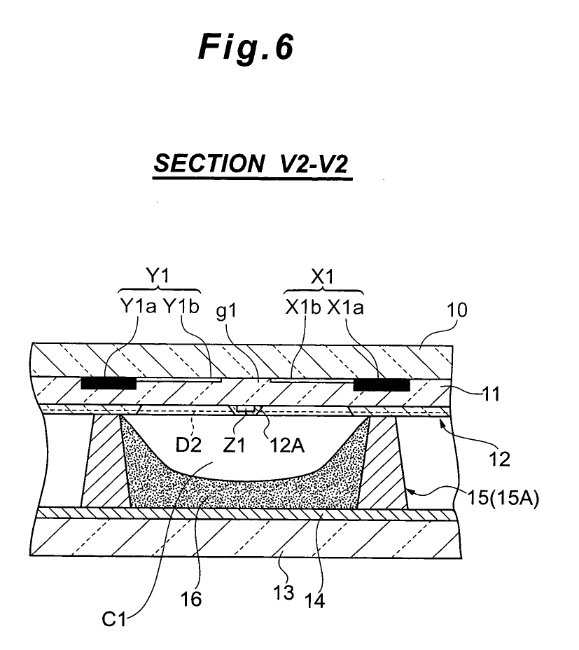

FIGS. 5 and 6 illustrate a third embodiment of the PDP according to the present invention. FIG. 5 is a schematic front view of the PDP in the third embodiment. FIG. 6 is a sectional view taken along the V2-V2 line in FIG. 5.

The first and second embodiments have described a PDP having the column electrodes D1 formed on the back glass substrate 13, whereas the PDP in the third embodiment as shown in FIGS. 5 and 6 has column electrodes D2 formed on the back-facing face of the front glass substrate 10.

More specifically, the dielectric layer 11 covers the row electrode pairs (X1, Y1), and each of the column electrodes D2 extends in the column direction on a portion of the back-facing face of the dielectric layer 11 opposite a mid-area between adjacent transparent electrodes X1b (Y1b) arranged at regular intervals along the associated bus electrodes X1a (Y1a) of the row electrode pairs (X1, Y1). The column electrodes D2 are covered by the additional dielectric layer 12 formed on the back-facing face of the dielectric layer 11.

The structure of the other components in this PDP is approximately the same as that in the first embodiment, and in FIGS. 5 and 6 the same components are designated with the same reference numerals as those in the first embodiment.

As in the case of the PDP in the first and second embodiments, in the PDP in the third embodiment the dielectric-formed protuberance 12A extending out into the interior of the discharge cell C1 in the portion opposite the discharge gap g1 allows the sustaining discharge between the transparent electrodes X1b, Y1b to develop in an area close to the central portion of the discharge cell C1. As a result, the efficiency of use of the vacuum ultraviolet light generated from the discharge gas is increased, and this increase enables an improvement in the luminous efficiency from the phosphor layers. Further, because of the location of the floating electrode Z1 in the protuberances 12A, although the discharge path of the sustaining discharge is increased by the provision of the protuberance 12A, the discharge voltage may not build up. Further, because room is allowed for initiating discharges between the transparent electrodes X1b, Y1b and the floating electrodes Z1, the electric field strength in the discharge occurring site is increased, leading to a reduction in discharge voltage.

The following is the procedure for manufacturing the foregoing PDP.

In the manufacturing process for the front glass substrate 10, first, the bus electrodes X1a, Y1a and the transparent electrodes X1b, Y1b are formed on the back-facing face of the front glass substrate 10 by means of patterning to form row electrodes X1, Y1.

After that, the dielectric layer 11 is further formed on the back-facing face of the front glass substrate 10 so as to cover the row electrodes X1, Y1.

After the formation of the dielectric layer 11, the column electrodes D2 are formed in predetermined positions on the back-facing face of the dielectric layer 11.

Then, the additional dielectric layer 12 is formed on the back-facing face of the dielectric layer 11. The column electrodes D2 are covered by the additional dielectric layer 12. The floating electrodes Z1 are formed in the protuberances 12A of the additional dielectric layer 12.

For forming the floating electrodes Z1, for example, each of the protuberances 12A of the additional dielectric layer 12 may be divided into two layers in order to be formed in stages. After the first layer has been formed, the floating electrode Z1 can be formed, and then the second layer can be formed so as to cover the floating electrode Z1.

The floating electrode Z1 is formed by use of methods such as the lamination of a silver film, solid printing of a photosensitive silver paste, pattern printing of a silver paste, Cr—Al—Cr evaporation, Al evaporation, or forming an ITO film.

After the formation of the additional dielectric layer 12 and the floating electrodes Z1, the MgO protective layer is formed to cover the surfaces of the dielectric layer 11 and the additional dielectric layer 12.

In the manufacturing process for the back glass substrate 13, the column-electrode protective layer 14 is formed on the front-facing face of the back glass substrate 13. Then, the partition wall units 15 are formed on the column-electrode protective layer 14, and then the red-, green- and blue-colored phosphor layers 16 are formed individually in the blank spaces created in each of the partition wall units 15.

Then, a sealing layer is formed on the periphery end of the front-facing face of the back glass substrate 13.

The front glass substrate 10 on which the components have been thus formed in the front-glass-substrate manufacturing process and the back glass substrate 13 on which the components have been thus formed in the back-glass-substrate manufacturing process are placed on and aligned with each other with the discharge space in between. Then, various processes, such as the sealing process for the discharge space and the process of removing gases from the interior of the discharge space and of baking, the process of introducing a discharge gas into the discharge space, and the chip-off process for the discharge gas, are performed in order to complete the PDP.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel having a pair of first and second substrates opposing each other across a discharge space, the first substrate being provided on an inner face thereof with a plurality of row electrode pairs that each extend in the row direction and are arranged in the column direction and a dielectric layer that covers the row electrode pairs, the discharge space being partitioned into areas to form unit light emitting areas each corresponding to paired discharge portions that are opposite each other across a discharge gap constituted by parts of row electrodes constituting each of the row electrode pairs, and the second substrate being provided on an inner face thereof with phosphor layers for the respective unit light emitting areas, the plasma display panel comprising:
dielectric protuberances that each extend out from a portion of the dielectric layer opposite the discharge gap between the row electrode pair toward the second substrate into the unit light emitting area; and
floating electrodes that are provided in the dielectric protuberances and are out of electric connection with the others.

2. A plasma display panel according to claim 1, wherein each of the floating electrodes is formed in an isolated-island form in each area opposite the discharge gap between the row electrode pair.

3. A plasma display panel according to claim 1, wherein each of the floating electrodes is formed in a strip shape extending continuously in the row direction along an area opposite a row of the discharge gaps lined up in the row direction between each row electrode pair.

4. A plasma display panel according to claim 1, wherein,
the row electrodes constituting each of the row electrode pairs individually have electrode bodies extending in the row direction, and electrode projecting portions that extend out from the associated electrode bodies toward their counterpart row electrodes in the pair and form the discharge portions facing each other across the discharge gap, and
a leading end of each of the electrode projecting portions which faces its counterpart electrode projecting portion in the pair with the discharge gap in between has a larger width in the row direction than that of a base end portion connected to the electrode body.

5. A plasma display panel according to claim 4, wherein the dielectric protuberance is formed in a projecting strip shape extending parallel to the wide leading end of the electrode projecting portion.

6. A plasma display panel according to claim 1, further comprising an additional dielectric layer that extends out from the dielectric layer toward the second substrate in an area of an inner face of the dielectric layer, except the discharge portion opposing the row electrode.

7. A plasma display panel according to claim 6, wherein the dielectric protuberances are formed integrally with the additional dielectric layer.

8. A plasma display panel according to claim 6, further comprising column electrodes that each extend in a direction at right angles to the row electrode pairs on the inner face of the dielectric layer, the column electrodes being covered by the additional dielectric layer.
